(19) United States
(12) Patent Application Publication
(10) Pub. No.: US 2026/0009665 A1
(43) Pub. Date: Jan. 8, 2026

(54) CORIOLIS MASS FLOW SENSORS

(71) Applicant: Malema Engineering Corporation, Boca Raton, FL (US)

(72) Inventors: Jayasekar Rajagopalan, Cupertino, CA (US); Renato De Castro, Cupertino, CA (US)

(21) Appl. No.: 18/765,016

(22) Filed: Jul. 5, 2024

(51) Int. Cl. G01F 1/84

(52) U.S. Cl. CPC G01F 1/8409; G01F 1/8404

(57) ABSTRACT

The present disclosure provides Coriolis mass flow sensors including: at least two flow tubes in fluidic communication with a flow distribution manifold formed from a single block of polymer material, the flow distribution manifold including: a manifold inlet at a first end of the flow distribution manifold; a manifold outlet at a second end of the flow distribution manifold, opposite the first end; a first flow path, formed within the single block of polymer material, that extends from the manifold inlet to a first set of openings in a surface of the flow distribution manifold; a second flow path, formed within the single block of polymer material, that extends from the manifold outlet to a second set of openings in the surface of the flow distribution manifold; and a channel retaining a temperature sensor, formed within the single block of polymer material, that intersects with the first flow path.

### BACKGROUND

The present disclosure generally relates to Coriolis mass flow sensors (also referred to as “flow sensors” or “flow cells”). Coriolis mass flow meters (also referred herein as “flow meters”) measure a mass flow rate of a fluid flowing through a tube based on Coriolis principles. Typical configurations employ one or two tubes through which the fluid flows and which are oscillated in a controlled manner. Coriolis induced deflections or the effects of such deflections on the tube(s) are measured to calculate the fluid mass flow rate of the fluid flowing through the sensor. Additionally, fluid density can also be measured (independently of mass flow rate) by measuring the change in the sensor's resonant frequency versus fluid density.

### SUMMARY

The present disclosure relates to a flow sensor for measuring flow rates and/or densities of different fluids. Various flow path configurations allow for different geometries of components within the flow sensor.

In some implementations, the flow sensor includes flow distribution manifold in the form of a solid body, providing flow paths via through holes in the solid body. The solid body can be composed of a variety of materials, including Gamma stable materials. Structure, such as supports, and components, such as temperature sensors, can provide stable and accurate sensors for measuring different flow characteristics.

In a first general aspect, a Coriolis mass flow sensor includes: at least two flow tubes in fluidic communication with a flow distribution manifold formed from a single block of polymer material, the flow distribution manifold including: a manifold inlet at a first end of the flow distribution manifold; a manifold outlet at a second end of the flow distribution manifold, opposite the first end; a first flow path, formed within the single block of polymer material, that extends from the manifold inlet to a first set of openings in a surface of the flow distribution manifold; a second flow path, formed within the single block of polymer material, that extends from the manifold outlet to a second set of openings in the surface of the flow distribution manifold; and a channel, formed within the single block of polymer material, that intersects with the first flow path. A respective first end of each flow tube can be connected to one opening of the first set of openings, and a respective second end of each flow tube can be connected to one opening of the second set of openings. The channel can be configured to retain a temperature sensor.

In a second, general aspect, a Coriolis mass flow sensor includes: at least two flow tubes in fluidic communication with a flow distribution manifold formed from a single block of polymer material, the flow distribution manifold including: a manifold inlet at a first end of the flow distribution manifold; a manifold outlet at a second end of the flow distribution manifold, opposite the first end; a first flow path, formed within the single block of polymer material, that extends from the manifold inlet to a first opening in a surface of the flow distribution manifold; a second flow path, formed within the single block of polymer material, that extends between a second opening and a third opening in the surface of the flow distribution manifold; a third flow path, formed within the single block of polymer material, that extends from the manifold outlet to a fourth opening in the surface of the flow distribution manifold; and a channel, formed within the single block of polymer material that intersects the first flow path. The channel can be configured to retain a temperature sensor. A first end of a first flow tube can be connected to the first opening. A second end of the first flow tube can be connected the second opening and a first end of a second flow tube is connected to the third opening. A second end of the second flow tube can be connected to the fourth opening.

In a third, general aspect, a Coriolis mass flow sensor includes: at least two flow tubes in fluidic communication with a flow distribution manifold formed from a single block of polymer material; an inlet fitting removably attached over the manifold inlet; an outlet fitting removably attached over the manifold outlet; a support positioned adjacent to the surface of the flow distribution manifold and surrounding a portion of each of the flow tubes and including isolation plates extending between the flow tubes; and an enclosure including an enclosure body and a lid. The flow distribution manifold can include: a manifold inlet at a first end of the flow distribution manifold; a manifold outlet at a second end of the flow distribution manifold, opposite the first end; a first flow path, formed within the single block of polymer material, that extends from the manifold inlet to a first set of openings in a surface of the flow distribution manifold; a second flow path, formed within the single block of polymer material, that extends from the manifold outlet to a second set of openings in the surface of the flow distribution manifold; O-rings inserted within each opening in the first set of openings and the second set of openings; and a channel, formed within the single block of polymer material, that intersects with the first flow path and is configured to retain a stainless steel temperature sensor. A respective first end of each flow tube can be connected to one opening of the first set of openings. A respective second end of each flow tube can be connected to one opening of the second set of openings. Each opening in the first set of openings and the second set of openings can include a first diameter that is larger than a respective second diameter, the first diameter sized to accommodate an O-ring. The second diameter can correspond with an outer diameter of the flow tubes. The flow tubes can be disposed within the enclosure body and the flow distribution manifold is mounted to a top surface of the lid. The channel can be oriented at an oblique angle to a second surface of the flow distribution manifold.

The general aspects can be combined with one or more of the following features.

In some implementations, the Coriolis mass flow sensor further includes: an inlet fitting removably attached over the manifold inlet; and an outlet fitting removably attached over the manifold outlet.

In some implementations, the temperature sensor includes stainless steel.

In some implementations, the temperature sensor is in communication with control circuitry, the control circuitry using measured temperatures to calibrate flow measurements.

In some implementations, the channel is oriented at an oblique angle to a second surface of the flow distribution manifold.

In some implementations, the channel is at least partially threaded.

In some implementations, the Coriolis mass flow sensor further includes a support positioned adjacent to the surface of the flow distribution manifold and surrounding a portion of each of the flow tubes.

In some implementations, the support includes isolation plates extending between the flow tubes.

In some implementations, the Coriolis mass flow sensor further includes an enclosure including an enclosure body and a lid. The flow tubes can be disposed within the enclosure body, and the flow distribution manifold can be mounted to a top surface of the lid.

In some implementations, the Coriolis mass flow sensor further includes a support positioned adjacent to the surface of the flow distribution manifold and surrounding a portion of each of the flow tubes. The support can be attached to the lid.

In some implementations, the first flow path and second flow path are formed within the flow distribution manifold by a molding process.

In some implementations, the first flow path and second flow path are formed within the flow distribution manifold by a machining process.

In some implementations, the polymer material includes a Gamma stable polymeric material.

In some implementations, each opening in the first set of openings and the second set of openings includes an O-ring inserted therein.

In some implementations, each opening in the first set of openings and the second set of openings includes a first diameter that is larger than a respective second diameter of the first flow path or the second flow path, the first diameter sized to accommodate an O-ring.

In some implementations, the flow tubes are attached to the flow distribution manifold by a friction fit within the first and second sets of openings.

In some implementations, the Coriolis mass flow sensor is configured to measure at least one of particular mass flow and density.

In some implementations, each flow sensor includes a plastic enclosure and can be sterilized by using Gamma irradiation.

The devices and techniques described here may provide one or more of the following advantages. For example, the Coriolis flow sensor described below may provide more stability to the measurement tubes, thereby, improving the accuracy of the sensor, increasing the range of the sensor, or both. The flow sensor described employes an inlet/outlet manifold that is formed from a single block of material. This monolithic manifold may aid in isolating the measurement tubes from vibrations external to the sensor. In addition, the manifold can include and integrated channel for receiving a temperatures sensor. Thus, in such implementation the monolithic manifold may also aid in isolating the sensor from any vibrations through connective wiring of the temperature sensor. Such improvements may be even more significant for light-weight polymer Coriolis flow sensors as compared to metal sensors.

### BRIEF DESCRIPTION OF THE DRAWINGS

FIG. 1 shows an example of a flow sensor according to implementations of the present disclosure.

FIG. 2A shows a cross-sectional view of the flow sensor of FIG. 1 along A-A’.

FIG. 2B shows a perspective view of flow tubes and other elements of the flow sensor of FIG. 1

FIG. 2C shows a cross-sectional view of the flow sensor of FIG. 1 along B-B’.

FIG. 3 shows a line diagram of fluid flow paths within the flow sensor of FIG. 1.

FIG. 4A shows a cross-sectional view of a flow distribution manifold, through which a channel extends. FIG. 4B is a perspective view of the flow distribution manifold.

FIGS. 5A, 5B, and 5C show different examples of flow path configurations in the flow distribution manifold of FIG. 4A.

FIG. 6 shows a line diagram of fluid flow paths within a flow sensor according to the flow path configuration of FIG. 5C.

Like reference numbers and designations in the various drawings indicate like elements.

### DETAILED DESCRIPTION

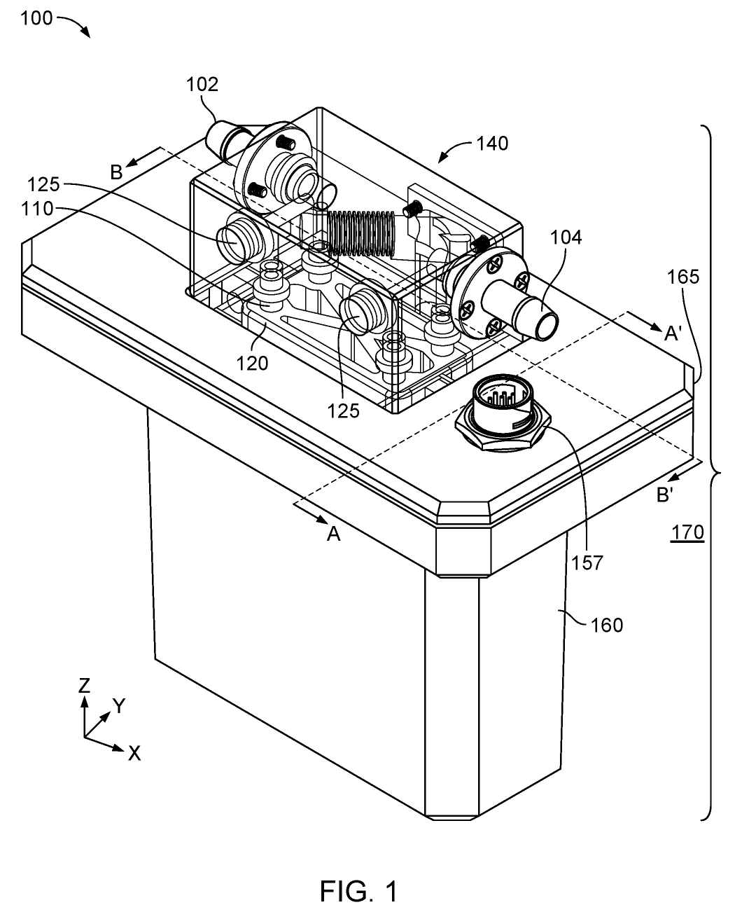

FIG. 1 shows an example of a flow sensor 100, e.g., a Coriolis mass flow sensor, according to implementations of the present disclosure. The flow sensor 100 measures flow characteristics (e.g., mass flow rate, volumetric flow rate, flow density, etc.). The flow sensor 100 receives fluid through inlet fitting 102, and fluid exits the flow sensor 100 through outlet fitting 104. The inlet fitting 102 and outlet fitting 104 are an inlet and an outlet of a flow distribution manifold 140, respectively. The flow distribution manifold 140 includes flow paths to guide fluid from the inlet fitting 102 to the outlet fitting 104, e.g., through fluidically coupled components. The inlet fitting 102 and outlet fitting 104 are attached to the manifold 140 over respective manifold inlet and manifold outlet (discussed below) that are formed within the manifold, e.g., molded or machined into the manifold block.

In some implementations, the flow distribution manifold 140 is disposed on an enclosure assembly 170, which includes a lid 165 and an enclosure 160. The enclosure assembly 170 encloses the flow tubes 110. The lid 165 can be mounted on, e.g., attached to, the enclosure 160, e.g., through bolts, screws, a snap fit, etc. The enclosure 160 can be formed as a cup into which the components of a flow sensor 100 can be inserted. The enclosure assembly 170 protects the flow sensor 100 from damage and or environmental factors that might adversely impact flow measurements. In some implementations, the enclosure assembly 170 is made of a polymer material, e.g., polycarbonate or PEEK.

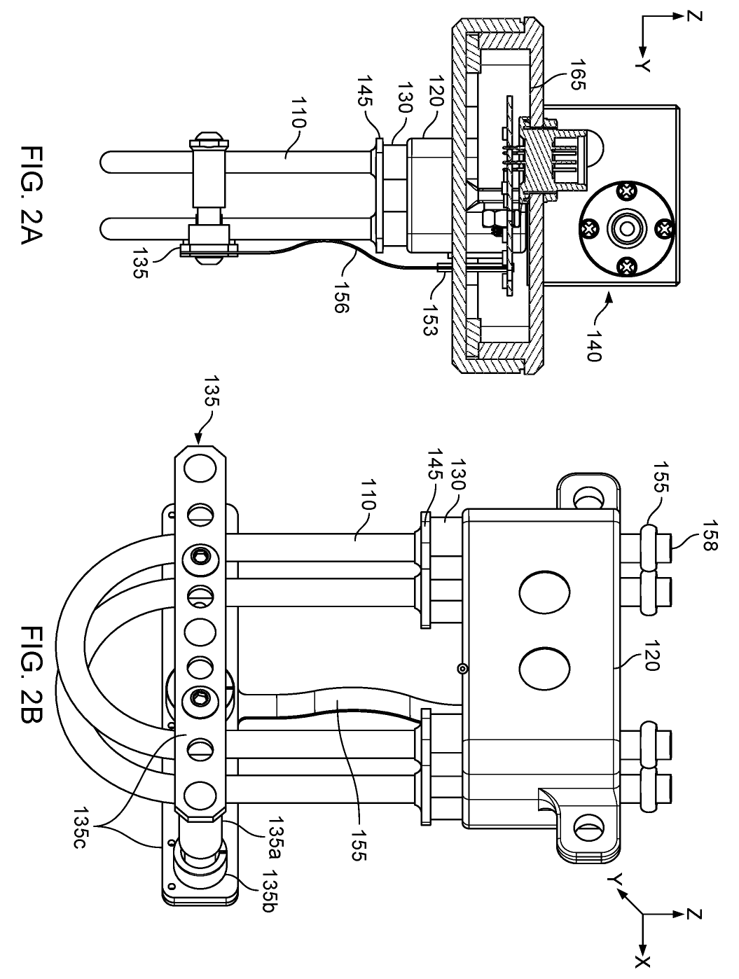

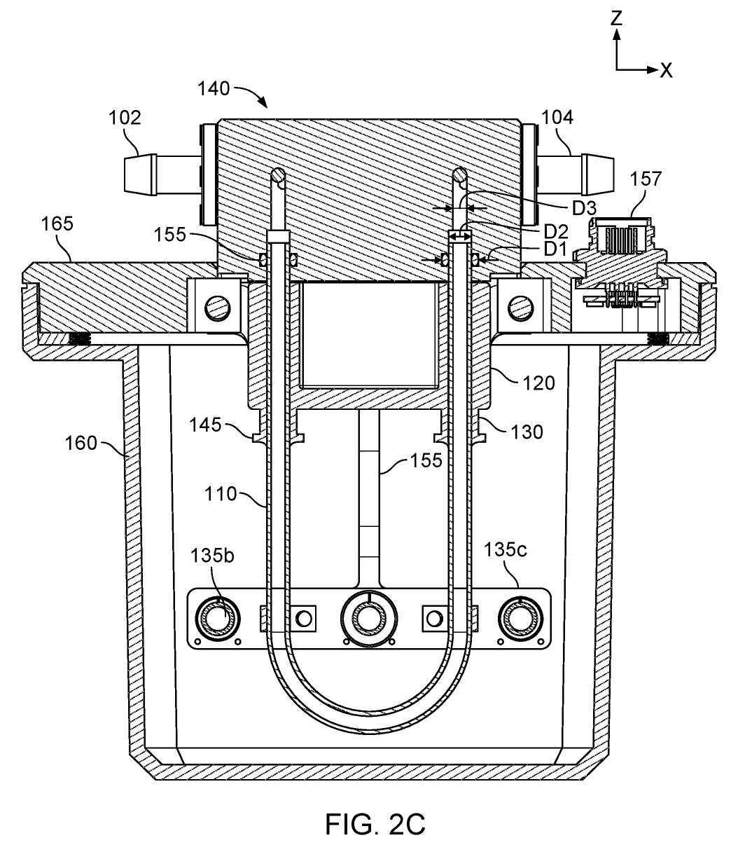

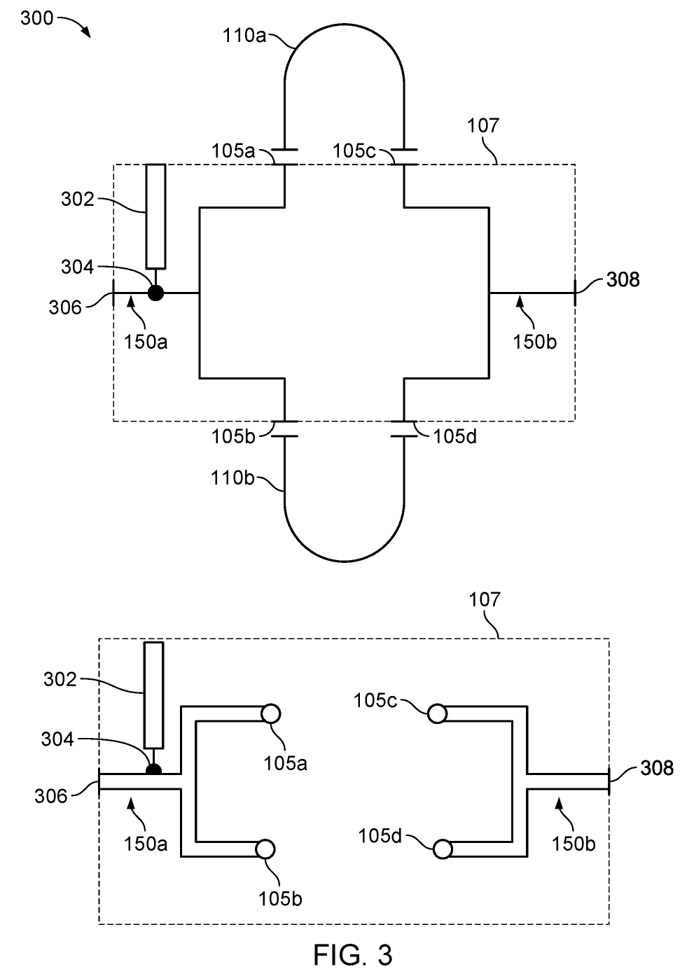

Referring to FIGS. 1 and 2A-2C, the flow sensor 100 includes flow tubes 110, support 120, and the flow distribution manifold 140, which are configured and arranged to provide various flow paths 150. The flow tubes 110 are disposed within the enclosure 160. In some examples, support 120 clamps the flow tubes 110. For example, the support 120 is sized to surround the flow tubes 110. The support 120 can serve to retain the flow tubes in place within the enclosure 160. The support 120 may provide a rigid base that insulates/isolates the flow tubes from vibrations that may occur in pipes/tubes outside of the flow sensor 100. Additionally, the support 120 can include port extensions 130 and isolation plates 145 that extend between the flow tubes 110. The port extensions 130 and isolation plates 145 can further aid in stabilizing the flow tubes 110.

The size, shape, and composition of the flow tubes 110 can determine a resonant frequency of the flow tubes, which is used to determine flow characteristics. In this example, there are two flow tubes 110 having the same size and shape. The flow tube 110 can have a curvilinear shape. For example, the flow tubes 110 are U-shaped flow tubes. One advantage of such a curvilinear shape is that there are no corners, which prevents abrupt changes in direction along the flow path of the fluid. Accordingly, possible accumulation of solids or any other contaminants inside the flow tubes 110 that may cause increased pressure drops or cause the flow tubes 110 to dislodge from the support 120, which can result in particle contamination, is reduced. In some implementations, the flow tube 110 has other shapes, such as V-shape, square, rectangular, triangular, elliptic, or straight.

The size and shape of the flow tubes 110 can affect a flow rate range of the flow sensor, e.g., a range of flow rates that the flow sensor 100 can measure. For example, the flow rate range depends on the inner diameter, e.g., a wall thickness, of one or more flow tubes of the flow sensor. For example, when the inner diameter of the flow tube is in the range from 0.1 mm to 0.3 mm, the flow rate range of the flow sensor is 0.05 g/min to 5 g/min. For example, when the inner diameter of the flow tube is in the range from 0.3 mm to 0.9 mm, the flow rate range of the flow sensor is 0.25 g/min to 50 g/min. For example, when the inner diameter of the flow tube is in the range from 5.5 mm to 6.5 mm, the flow rate range of the flow sensor is 15 g/min to 3 kg/ min. For example, when the inner diameter of the flow tube is in the range from 7.8 mm to 12.5 mm, the flow rate range of the flow sensor is 90 g/min to 20 kg/ min. For example, when the inner diameter of the flow tube is in the range from 15 mm to 60 mm, the flow rate range of the flow sensor is 1 kg/min to 250 kg/min.

In some implementations, there are two identical flow tubes 110, i.e., the flow tubes 110 have identical shape and dimensions. Other implementations can include other numbers of flow tubes, e.g., three or more. In some implementations, the two flow tubes 110 can be different in size, shape, and materials. The flow tubes 110 may be made of metal (such as stainless steel) or a polymer material (such as Polyetheretherketone (PEEK), Perfluoroalkoxy polymers (PFAs), polyvinylidene difluoride (PVDF), Polytetrafluoroethylene (PTFE), and Fluorinated ethylene propylene (FEP)).

The inlet fitting 102 and outlet fitting 104 can be releasably attached to the manifold 140. For example, the inlet and outlet fittings 102, 104 can be attached by mechanical fasteners threaded through a flange at the base of the fitting. The outboard ends of the fittings (i.e., the end outboard of the manifold, e.g., opposite the attachment flange) can be configured with an attachment mechanism for attaching to external tubing or piping. Exemplary attachment mechanisms include a barbed end and a tri-clamp connection. Because the fittings are removable, different sizes fittings can be attached to a given flow distribution manifold 140, which makes the manifold 140 adaptable to different fluid systems with tubing/pipes of different sizes.

FIG. 2A shows a cross-sectional view of the flow sensor 100 along A-A’ from FIG. 1, and FIG. 2B shows a perspective view of components sof the flow sensor 100 that are normally disposed within the enclosure and other elements of the flow sensor 100. FIG. 2C shows a cross-sectional view of the flow sensor 100 along B-B’ from FIG. 1. The flow tubes 110 are fluidically coupled to flow paths within the flow distribution manifold 140. For example, each end 158 of the flow tubes 110 can be fluidically coupled to a respective opening in the flow distribution manifold 140.

In some implementations, in order to provide better sealing between the flow tubes 110 and the manifold 140, an O-ring 155 can be disposed around the ends 158 of the flow tubes 110. In such implementations, the openings within the flow distribution manifold 140 can have different diameters to conformally surround the flow tubes 110 and the O-rings 155 within the manifold 140. For example, a pocket can be formed within the manifold 140 to accommodate the O-rings 155 which a greater diameter (D1) than the diameter (D2) of the flow tubes 110. In some implementations, the openings within the manifold 140 into which the flow tubes 110 are inserted are formed with three different internal diameters: D1, D2, and D3. The diameter D1 is greater than each of diameters D2 and D3. D1 corresponds with the size of the O-rings 155 used to seal the flow tubes 110. D2 corresponds with the outer diameter of the flow tubes 110. D2 can be formed to a relatively tight tolerance to create a friction fit with the outer surface of the flow tubes 110. D3 is the diameter of the internal flow paths within the manifold 140. D2 can be formed larger than D3 in some implementations. In other implementations, D2 and D3 are formed with equal diameters.

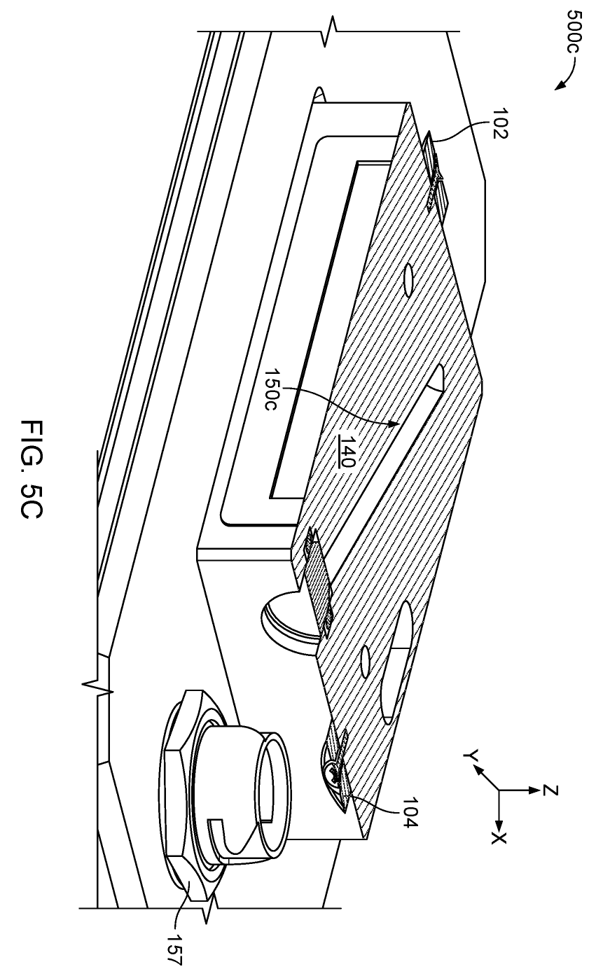

In some implementations, the flow tubes 110 are attached to the flow distribution manifold 140 by a friction fit within the openings, e.g., the openings are sized and shaped to just fit the flow tubes with a small tolerance. In some implementations, the flow tubes 110 can be adhered within the openings (e.g., see openings 159 that connect to the flow tubes in FIG. 5B) of the manifold 140, e.g., using an adhesive or epoxy. In some implementations, the flow tubes 110 can be welded to the manifold 140.

The support 120 provides structural support for the flow tubes 110. The support 120 may be fabricated by casting around the tubular legs of the flow tubes 110 or formed around the tubular legs of the flow tubes 110 through over-molding. The support 120 includes tubular channels through which the flow tubes 110 extend. The support 120 clamps the outer surface of the two tubular legs of each of the flow tubes 110 to hold the flow tubes 110. Compared with other fabrication methods (e.g., injection molding), pressure exerted on the flow tubes 110 and temperature of the flow tubes 110 during the casting process is low so that deformation of the flow tubes 110 can be avoided.

The port extensions 130 clamp the tubular legs of the flow tubes 110. An inner surface of each port extension 130 contacts the outer surface of the corresponding tubular leg. The isolation plates 145 connect adjacent port extensions 130. The isolation plates 145 can establish the boundary conditions of vibration of the flow tubes 110 and maintain stability of the flow tubes 110. The flow tubes 110 can vibrate in opposite phases (referred to as “anti-phase vibration”) similar to a tuning fork and vibrate together in unison (referred to as “in-phase vibration”). The natural frequencies of the anti-phase vibration and in-phase vibration can be close or even identical, resulting in vibrational excitation energy shared uncontrollably between the two vibrational modes, which causes instability of the flow tubes 110. The vibrational boundary conditions created by the isolation plates 145 can separate the natural frequencies of the anti-phase vibration and in-phase vibration to prevent instability of the flow sensor 100. The dimensions and thickness of the isolation plates 145 can be determined based on the frequency response characteristics of the flow tubes 110. In some implementations, the isolation plates 145 are integrated with the port extensions 130, both of which are integrated with the support 120.

An electromagnetic assembly 135 drives vibration of the flow tubes 110. The electromagnetic assembly 135 can include magnets 135a, coils 135b, and racks 135c. The magnets 135a are mounted on one of the racks 135c, which is attached to one of the flow tubes 110. The coils are mounted to the other rack, which is attached to the other flow tube 110. One of the three coils 135b, e.g., the coil in the middle, can receive an alternating current, e.g., from a controller (e.g., a flow transmitter) connected to the flow sensor 100. The alternating current causes the magnet 135a corresponding to the coil 135b to be attracted and repelled, thereby driving the flow tubes 110 to move towards and away from each another.

The electromagnetic assembly 135 also detects changes in the vibration of the flow tubes 110 due to the flow of the fluid and outputs electrical signals that can be used to measure flow rate and density of the fluid. When the fluid flows through the flow tubes 110, Coriolis forces produce a twisting vibration of the flow tubes 110, which results in a phase shift. As the magnets and coils are mounted on the flow tubes, the phase shift can be captured by the magnets and coils, e.g., represented by electrical signals of the coils and be used to determine a mass flow rate of the fluid.

The density of the fluid relates to the resonant frequency of the flow tubes 110. The density of the fluids can thereby be determined by monitoring the change in the resonant frequency of the flow tubes 110. The resonant frequency of the flow tubes 110 depends at least on the density of the fluid present in the flow tubes 110 and the density of a material of the flow tubes 110.

The presence of the first fluid changes the resonant frequency of the flow tubes 110. The mass flow rate of the fluid can be directly determined based on the phase shift. The density of the fluid can be directly determined based on the change in vibration resonant frequency. The flow sensor 100 generates signals, e.g., electrical signals, that represent the phase shift and/or change in its resonant frequency. The signals are sent to the controller, e.g., control circuitry 153, to be used for controlling the flow sensor 100.

An interface cable 156 connects the coils 135b to the control circuitry 153. The control circuitry 153 can provide structural support for components mounted on it, such as a memory chip. The memory chip stores calibration information of the flow sensor 100. The calibration information can be used to adjust a flow rate or density measured by the flow sensor 100. In some implementations, the calibration information includes a plurality of calibration factors. Each calibration factor is for adjusting a flow rate, such as a low flow rate (e.g., about 1 liter/minute), medium flow rate (e.g., about 10 liter/minute), or high flow rate (e.g., from 20 liter/minute to 200 liter/minute). The calibration information can be read out from the memory chip, e.g., by a flow transmitter.

In some implementations, the flow sensor 100 also includes a memory chip (not shown) that stores calibration information that can be used to adjust flow measurements made by the flow sensor 100. For instance, the calibration information can include one or more flow rate calibration factors. Each flow rate calibration factor indicates a difference between a flow rate measured by the flow sensor 100 and a reference flow rate and can be used to adjust flow rates measured by the flow sensor 100. The calibration information can also include one or more flow density calibration factors. Each flow density calibration factor indicates a difference between a flow density measured by the flow sensor 100 and a reference flow density and can be used to adjust flow densities measured by the flow sensor 100. The calibration information can be determined during manufacturing.

The control circuitry 153 receives signals from the flow sensor 100 and conducts flow analysis based on the signals. The flow analysis includes, for example, determination of flow rate based on signals representing phase shift of the flow tubes 110, determination of flow density based on signals representing change in resonant frequency of the flow tubes 110, detection of bubbles in the fluid based on change in flow density, determination of other flow characteristics of the fluid, or some combination thereof.

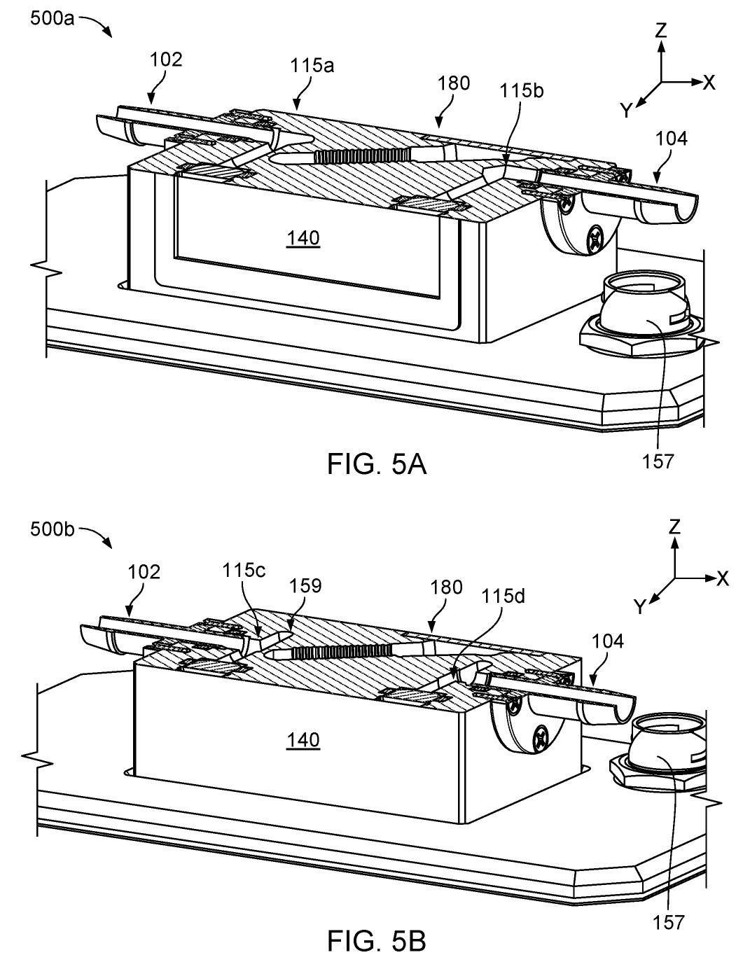

The control circuitry 153 can read out the calibration information from the memory chip of the flow sensor 100 and use the calibration information in its flow analysis. For example, the controller uses a flow rate calibration factor to determine a flow rate of the fluid or uses a flow density calibration factor to determine a density of the fluid. As will be discussed in relation to FIG. 4A and 4B, the control circuitry 153 can also receive temperature information from the temperature probe and use the temperature information to dynamically adjust the flow analysis. For instance, the controller can input the temperature information into a model and the model can output adjusted flow rate and/or flow density.

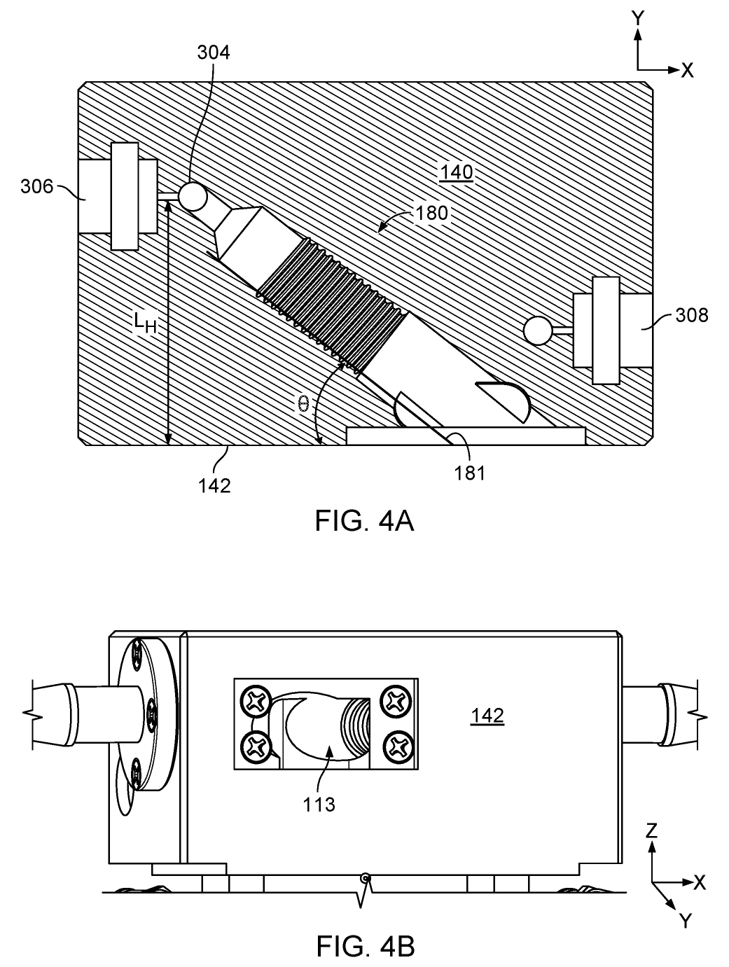

FIG. 3 shows a line diagram 300 of fluid flow paths within the manifold 140. The line diagram 300 represents the flow paths within the manifold 140 in a planar view and does not reflect the physical three dimensional layout of the flow path within the manifold 140. Diagram 300 is illustrated in a planar view to show the connections to the flow tubes 110a, 110b. For example, the line segments of the line diagram 300 are depicted as extending in the plane of FIG. 3 when the segments would extend into or out of the page in physical space. Outline 107 marks the boundary of the flow distribution manifold 140, and segments of the line diagram 300 outside of the outline 107 would be below rather than next to segments within the outline 107. Diagram 350 is a line diagram depicting the flow paths within the manifold 140 from the perspective bottom surface of the manifold 140.

The combined flow paths of the line diagrams 300 and 350 are referred to as a “flow path assembly.” The flow path assembly begins at the manifold inlet 306 and ends at the manifold outlet 308. A first flow path 150a starts at the manifold inlet 306 until the flow path diverges at a first set of openings 105a and 105b. The first set of openings 105a and 105b are openings in a bottom surface (e.g., a lower surface, e.g., as along the Z direction, of the flow distribution manifold in the X-Y plane) of the flow distribution manifold 140, which can be sized and arranged to fluidically couple to first ends of flow tubes 110a and 110b, respectively.

From the first set of openings 105a and 105b, fluid flows through the flow tubes 110a and 110b to a second set of openings 105c and 105d. The second set of openings 105c and 105d are openings in the bottom surface of the flow distribution manifold 140, which can be sized and arranged to fluidically couple to second ends of the flow tubes 110a and 110b, respectively. In a second flow path 150b, the fluids coming from each of the second set of openings 105c and 105d converge as the fluid moves toward the manifold outlet 308.

In some implementations, a probe of the temperature sensor 302 intersects the inlet flow path 150a at an intersection 304. The temperature sensor 302 may extend slightly into the flow path 150a to permit thermal contact with a fluid flowing through the flow path 150a.

The pathways of flow path assembly, e.g., the first and second flow paths 150a and 150b, can be formed by various processes, such as machining or molding. For example, the first and second flow paths 150a and 150b can be within the flow distribution manifold 140 and correspond to through holes within the flow distribution manifold 140. In other words, the flow distribution manifold 140 can be a single, solid block of material, where the flow paths are formed by removing material from the solid block, e.g., through machining. The manifold inlet 306 and manifold outlet 308 correspond to opposite ends of the through holes throughout the flow distribution manifold 140, e.g., opposite side surface of the flow distribution manifold 140. Although the two ends of the through holes are referred to as inlet and outlet, in some implementations, the flow of fluid can be reversible, such that the manifold inlet 306 functions as an outlet and the manifold outlet 308 functions as an inlet.

In some implementations, e.g., when the flow paths within the manifold 140 are machined, the manifold 140 includes plugs 125 within an outer surface of the manifold 140 to close external openings to segments of the internal flow paths formed during the milling process. The plugs can be sealed using, e.g., O-rings or a welded seal. Similar to the O-ring geometry used to seal the flow tubes (described above in reference to FIG. 2C), the flow paths where the plugs 125 are inserted can be formed with an expanded diameter into which the O-rings are inserted to create a liquid tight seal.

In some implementations, the material composition of the flow distribution manifold 140 is polymer material that has been Gamma stabilized. As a result, the polymeric material can be a Gamma stable material.

With reference to FIGS. 4A and 4B, a channel 180 can extend from a side surface 142 through the flow distribution manifold 140 to an intersection 304. The channel 180 can be sized and shaped to receive a temperature sensor. For example, the length and width of the channel 180 can be large enough to accommodate the temperature sensor. In some implementations, the channel 180 is sized to accommodate temperature sensor of a predetermined minimum length, e.g., along axis 181 of the channel 180, that is greater than the horizontal length L_{H}, e.g., as measured along the Y axis, between the manifold inlet 306 and the side surface 142. To accommodate the temperature sensor, the channel 180 can be formed in the flow distribution manifold 140 at an oblique angle θ, e.g., the angle between the axis 181 and the side surface 142. In some implementations, the range for the oblique angle θ can be between 20° and 70°. In some implementations, the range for the oblique angle θ can be between 30° and 60°. In some implementations, the oblique angle θ is tailored to the length of a particular temperature sensors relative to the width of the manifold 140. For example, the angle θ can be formed such that the full length of a temperature sensor is accommodated within the body of the manifold. In other words, the angle θ is formed such that the length of channel 180 corresponds with a length of the temperatures sensor that is installed therein.

FIG. 4B depicts the side surface 142 with an opening 113 where the channel 180 begins. Although not depicted in FIG. 4B, a plate can be bolted over the opening 113 on the side surface 142 to seal off the channel 180.

In some implementations, the channel 180 is threaded, e.g., at least partially threaded. When the channel 180 is threaded, the temperature sensor can also be threaded, such that the sensor can be securely screwed into place during operation of the flow sensor 100. In some implementations, the temperature sensor includes stainless steel.

In some implementations, the temperature sensor measures and communicates temperatures of fluid in the first flow path 150a to the control circuitry 153. The control circuitry 153 can use the measured temperatures to adjust calculations for flow rates and/or densities measured by the flow sensor 100. For example, a function for calculating the flow rate of fluid within the flow distribution manifold 140 can depend on the temperature of fluid in the first flow path 150a, so the measured temperatures can be used to calibrate flow measurements. The measured temperatures can also be used to determine operational parameters of the flow sensor 100.

For the flow paths 150a and 150b of line diagram 300, there are various possible configurations for the physical layout. FIGS. 5A and 5B show two examples of different physical layouts corresponding to line diagram 300. Each of FIGS. 5A and 5B are perspective, cross-sectional views (e.g., a cross-section along the vertical Z axis) of the flow paths within the flow distribution manifold 140.

In view 500a, fluid enters the inlet fitting 102, and the first flow path 150a splits at a juncture 115a. Although the entire fluid flow assembly is not visible in FIG. 5A, at juncture 115a, some of the fluid in the first fluid flow path 150a travels downward toward a first end of a first flow tube 110a, e.g., toward opening 105a, and the remaining part of the fluid in the first fluid flow path 150a turns, e.g., at approximately a right angle, and travels toward a first end of a second flow tube 110b, e.g., toward opening 105b.

At juncture 115b, fluid flowing through each of the flow tubes 110a and 110b re-combines, e.g., fluid from the first flow tube 110a travels straight upward toward juncture 115b, and fluid from the second flow tube 110b turns toward the juncture 115b after exiting the second flow tube 110b. The recombined fluids form second flow path 150b, which flows toward the outlet fitting 104.

The fluid flow assembly of FIG. 5A corresponds to a nonsymmetric layout of the first and second flow paths 150a and 150b along the X axis, although the first and second flow paths 150a and 150b are symmetric along the Y axis. For example, the inlet fitting 102 and the outlet fitting 104 are not centered between the ends of the fluid flow tubes 110 (not visible in FIG. 5A). Rather, the inlet fitting 102 and outlet fitting 104 are aligned with the first fluid flow tube 110a, e.g., along the X axis, so that the junctures 115a and 115b are directly above the first fluid flow tube 110a. In other words, the junctures 115a and 115b vertically overlap the first fluid flow tube 110a and do not vertically overlap the second fluid flow tube 110b.

In view 500b, fluid enters the inlet fitting 102, and the first flow path 150a splits at juncture 115c. At juncture 115c, part of the fluid turns, e.g., approximately 90°, in a direction toward the first flow tube 110a, and the remaining portion of the fluid turns in the opposite direction toward the second flow tube 110b. After traveling through the respective flow tubes, each portion of the fluid turns toward juncture 115, where the portions of the fluid recombine to form second flow path 150b.

The fluid flow assembly of FIG. 5A corresponds to a symmetric layout of the first and second flow paths 150a and 150b along the X and Y axes. For example, the inlet fitting 102 and the outlet fitting 104 are centered between the ends of the fluid flow tubes 110a and 110b (not visible in FIG. 5B). As a result, the junctures 115a and 115b are not directly above either of the first or second fluid flow tube 110a or 110b. In other words, the junctures 115a and 115b do not vertically overlap either of the first or second fluid flow tubes 110a or 110b.

In views 500a and 500b, the cross-section along the Z-axis is at a level where the channel 180 for the temperature sensor does not yet intersect the first fluid flow path 150a. However, at a different height, the cross-section will reveal the intersection of the channel 180 and the first fluid flow path 150a. In some implementations, as depicted in FIG. 4A, the intersection of the channel 180 and the first fluid flow path 150a, e.g., intersection 304, occurs at the juncture, e.g., junctures 115a or 115c, where the first fluid flow path 150a splits toward multiple openings. In some implementations, the intersection 304 occurs after the juncture where the first fluid flow path 150a splits toward multiple openings.

Which physical layout of FIGS. 5A and 5B is used for the flow distribution manifold 140 can depend on the location of the connector 157, which connects the flow sensor 100 to external components, e.g., to another fluid flow manifold or flow sensor. For example, in the nonsymmetric layout of FIG. 5A, the connector 157 is centered relative to the flow distribution manifold 140, e.g., along the Y axis, so that the connector 157 does not vertically overlap the outlet fitting 104. In the symmetric layout of FIG. 5B, the connector 157 is not centered relative to the flow distribution manifold 140. Rather, the connector 157 is displaced along the Y axis, e.g., on the side of the flow distribution manifold 140, so that the centered outlet fitting 104 does not directly overlie the connector 157.

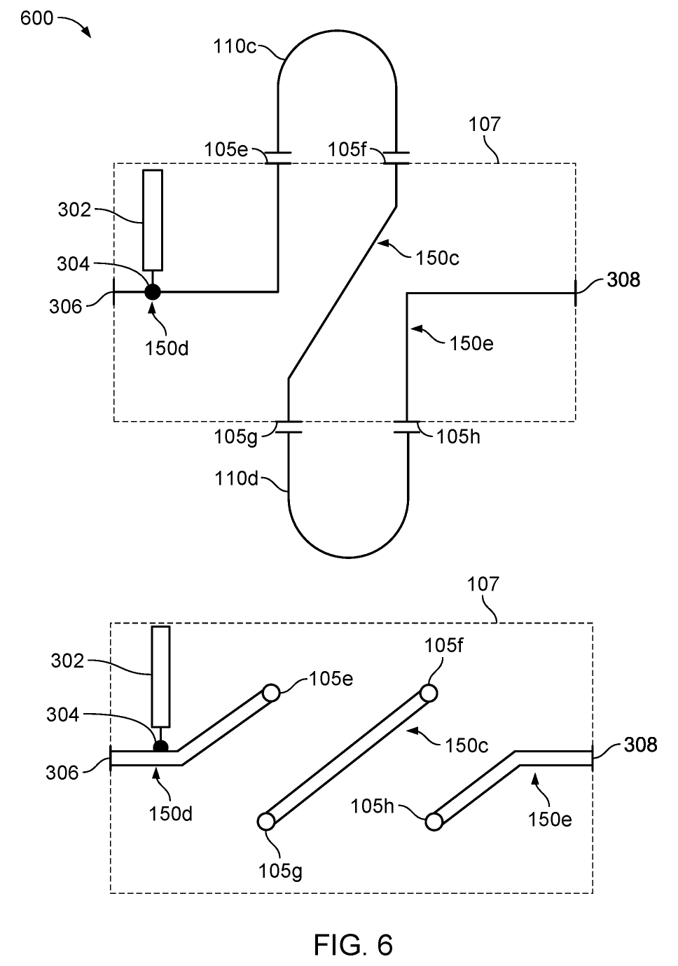

FIG. 5C depicts a physical layout of a fluid flow assembly in another example of a flow sensor. Similarly to FIGS. 5A and 5B, FIG. 5C is a cross-sectional, perspective view of a flow distribution manifold 140. In addition to fluid flow paths (as will be discussed with reference to FIG. 6) coupled to the inlet fitting 102 and outlet fitting 104, there is a fluid flow path 150c that diagonally extends, e.g., along a direction having components in both the X and Y axes, through the flow distribution manifold 140 to connect ends of different fluid flow tubes.

FIG. 6 depicts line diagrams 600, 650 of an alternate embodiment of the flow distribution manifold 140 with flow paths that result in a serial fluid flow through the two flow tubes of a flow sensor 100. Diagrams 600 and 650 depict the fluid flow in a flow distribution manifold 140 having the physical layout of FIG. 5C. Diagram 600 represents the flow paths within the manifold 140 in a planar view and does not reflect the physical three dimensional layout of the flow path within the manifold 140. Diagram 600 is illustrated in a planar view to show the connections to the flow tubes 110a, 110b. Diagram 650 is a line diagram depicting the flow paths within the manifold 140 from the perspective bottom surface of the manifold 140.

The fluid flow assembly begins with a first flow path 150d beginning at manifold inlet 306. Fluid in the first flow path 150d flows toward a first opening 105e, which can be fluidically coupled to a first flow tube 110c. The fluid flows from the first opening 105e of the flow tube 110c to a second opening 105f of the flow tube 110c. Then the fluid flows, along flow path 150c, from the second opening 105f of the flow tube 110c to a third opening 105g of a second flow tube 110d. The fluid flows from the third opening 105g to a fourth opening 105h of the second flow tube 110d. From the fourth opening 105h, the fluid flows into the third fluid flow path 150e toward the manifold outlet 308.

Such a layout as in FIG. 6 can be referred to as a “serial” layout, as fluid flows in series from one flow tube 110c to another flow tube 110d. In contrast, the layout of FIG. 3 can be referred to as a “parallel” layout, as fluid flows through both flow tubes 110a and 110b in parallel.

In this specification, the terms “top” and “bottom” refer to orientations as depicted in the figures which represent the typical orientations of some embodiments of the flow sensors. However, in other implementations the flow sensors may be operated in other orientations.

The language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosure of the embodiments is intended to be illustrative, but not limiting, of the scope of the disclosure, which is set forth in the following claims.

What is claimed is:

1. A Coriolis mass flow sensor comprising:
at least two flow tubes in fluidic communication with a flow distribution manifold formed from a single block of polymer material, the flow distribution manifold comprising:
a manifold inlet at a first end of the flow distribution manifold;
a manifold outlet at a second end of the flow distribution manifold, opposite the first end;
a first flow path, formed within the single block of polymer material, that extends from the manifold inlet to a first set of openings in a surface of the flow distribution manifold, wherein a respective first end of each flow tube is connected to one opening of the first set of openings;
a second flow path, formed within the single block of polymer material, that extends from the manifold outlet to a second set of openings in the surface of the flow distribution manifold, wherein a respective second end of each flow tube is connected to one opening of the second set of openings; and
a channel, formed within the single block of polymer material, that intersects with the first flow path, wherein the channel is configured to retain a temperature sensor.

2. The Coriolis mass flow sensor of claim 1, comprising:
an inlet fitting removably attached over the manifold inlet; and
an outlet fitting removably attached over the manifold outlet.

3. The Coriolis mass flow sensor of claim 1, wherein the temperature sensor comprises stainless steel.

4. The Coriolis mass flow sensor of claim 1, wherein the temperature sensor is in communication with control circuitry, the control circuitry using measured temperatures to calibrate flow measurements.

5. The Coriolis mass flow sensor of claim 1, wherein the channel is oriented at an oblique angle to a second surface of the flow distribution manifold.

6. The Coriolis mass flow sensor of claim 1, wherein the channel is at least partially threaded.

7. The Coriolis mass flow sensor of claim 1, further comprising a support positioned adjacent to the surface of the flow distribution manifold and surrounding a portion of each of the flow tubes.

8. The Coriolis mass flow sensor claim 7, wherein the support comprises isolation plates extending between the flow tubes.

9. The Coriolis mass flow sensor of claim 1, further comprising an enclosure comprising an enclosure body and a lid, wherein the flow tubes are disposed within the enclosure body and the flow distribution manifold is mounted to a top surface of the lid.

10. The Coriolis mass flow sensor of claim 9, further comprising a support positioned adjacent to the surface of the flow distribution manifold and surrounding a portion of each of the flow tubes, wherein the support is attached to the lid.

11. The Coriolis mass flow sensor of claim 1, wherein the first flow path and second flow path are formed within the flow distribution manifold by a molding process.

12. The Coriolis mass flow sensor of claim 1, wherein the first flow path and second flow path are formed within the flow distribution manifold by a machining process.

13. The Coriolis mass flow sensor of claim 1, wherein the polymer material comprises a Gamma stable polymeric material.

14. The Coriolis mass flow sensor of claim 1, wherein each opening in the first set of openings and the second set of openings comprises an O-ring inserted therein.

15. The Coriolis mass flow sensor of claim 14, wherein each opening in the first set of openings and the second set of openings comprises a first diameter that is larger than a respective second diameter of the first flow path or the second flow path, the first diameter sized to accommodate an O-ring.

16. The Coriolis mass flow sensor of claim 1, wherein the flow tubes are attached to the flow distribution manifold by a friction fit within the first and second sets of openings.

17. The Coriolis mass flow sensor of claim 1, wherein the Coriolis mass flow sensor is configured to measure at least one of particular mass flow and density.

18. A Coriolis mass flow sensor comprising:
at least two flow tubes in fluidic communication with a flow distribution manifold formed from a single block of polymer material, the flow distribution manifold comprising:
a manifold inlet at a first end of the flow distribution manifold;
a manifold outlet at a second end of the flow distribution manifold, opposite the first end;
a first flow path, formed within the single block of polymer material, that extends from the manifold inlet to a first opening in a surface of the flow distribution manifold, wherein a first end of a first flow tube is connected to the first opening;
a second flow path, formed within the single block of polymer material, that extends between a second opening and a third opening in the surface of the flow distribution manifold, wherein a second end of the first flow tube is connected the second opening and a first end of a second flow tube is connected to the third opening;
a third flow path, formed within the single block of polymer material, that extends from the manifold outlet to a fourth opening in the surface of the flow distribution manifold, wherein a second end of the second flow tube is connected to the fourth opening; and
a channel, formed within the single block of polymer material that intersects the first flow path, wherein the channel is configured to retain a temperature sensor.

19. The Coriolis mass flow sensor claim 18, comprising:
an inlet fitting removably attached over the manifold inlet; and
an outlet fitting removably attached over the manifold outlet.

20. The Coriolis mass flow sensor claim 18, wherein the polymer material comprises a Gamma stable polymeric material.

21. A Coriolis mass flow sensor comprising:
at least two flow tubes in fluidic communication with a flow distribution manifold formed from a single block of polymer material,
wherein the flow distribution manifold comprises:
a manifold inlet at a first end of the flow distribution manifold;
a manifold outlet at a second end of the flow distribution manifold, opposite the first end;
a first flow path, formed within the single block of polymer material, that extends from the manifold inlet to a first set of openings in a surface of the flow distribution manifold, wherein a respective first end of each flow tube is connected to one opening of the first set of openings;
a second flow path, formed within the single block of polymer material, that extends from the manifold outlet to a second set of openings in the surface of the flow distribution manifold, wherein a respective second end of each flow tube is connected to one opening of the second set of openings;
O-rings inserted within each opening in the first set of openings and the second set of openings, wherein each opening in the first set of openings and the second set of openings comprises a first diameter that is larger than a respective second diameter, the first diameter sized to accommodate an O-ring, and wherein the second diameter corresponds with an outer diameter of the flow tubes; and
a channel, formed within the single block of polymer material, that intersects with the first flow path and is configured to retain a stainless steel temperature sensor, wherein the channel is oriented at an oblique angle to a second surface of the flow distribution manifold;
an inlet fitting removably attached over the manifold inlet;
an outlet fitting removably attached over the manifold outlet;
a support positioned adjacent to the surface of the flow distribution manifold and surrounding a portion of each of the flow tubes and comprising isolation plates extending between the flow tubes; and
an enclosure comprising an enclosure body and a lid, wherein the flow tubes are disposed within the enclosure body and the flow distribution manifold is mounted to a top surface of the lid.
